(19) United States
(12) Patent Application Publication
(10) Pub. No.: US 2016/0316810 A1
(43) Pub. Date: Nov. 3, 2016

(54) NUTRITIONAL COMPOSITION CONTAINING OXIDIZABLE OIL AND ROSMARINIC ACID

(71) Applicant: ABBOTT LABORATORIES, Abbott Park, IL (US)

(72) Inventors: MEGAN TERP, Columbus, OH (US); YOUNGSUK HEO, Powell, OH (US); NORMANELLA DEWILLE, Columbus, OH (US)

(73) Assignee: ABBOTT LABORATORIES, Abbott Park, IL (US)

(21) Appl. No.: 15/104,898

(22) PCT Filed: Dec. 18, 2014
(86) PCT No.: PCT/US2014/071200

§ 371 Date: Jun. 15, 2016

Related U.S. Application Data
(60) Provisional application No. 61/918,815, filed on Dec. 20, 2013.

(51) Int. Cl. A23L 33/00; A23L 33/12; A23L 33/125; A23L 33/17

(52) U.S. Cl. CPC A23L 33/40; A23L 33/17; A23L 33/12; A23L 33/125; A23V 2002/00

(57) ABSTRACT

A nutritional composition including an oxidizable oil and rosmarinic acid is provided. The rosmarinic acid protects the flavor and aroma of the nutritional composition by reducing oxidation of the oxidizable oil and reducing or otherwise masking off-flavors and aromas.

### CROSS-REFERENCE TO RELATED APPLICATIONS

This application claims priority to and any benefit of U.S. Provisional Application No. 61/918,815, filed Dec. 20, 2013, the content of which is incorporated herein by reference in its entirety.

### FIELD

The general inventive concepts relate to nutritional compositions. More particularly, the general inventive concepts relate to a nutritional composition comprising an oxidizable oil and rosmarinic acid, and a method of reducing off-flavors and aromas in a nutritional composition comprising an oxidizable oil.

### BACKGROUND

A growing body of evidence suggests that regular consumption of certain amounts of unsaturated fatty acids, such as omega-3 polyunsaturated fatty acids, may provide various health benefits. As a result, a number of nutritional compositions are being formulated to contain these unsaturated fatty acids. However, many of these unsaturated fatty acids are prone to oxidation, which often results in highly objectionable flavors and aromas that have been described as fishy, painty, or otherwise rancid.

### SUMMARY

The general inventive concepts relate to a nutritional composition comprising an oxidizable oil and rosmarinic acid, and a method of reducing off-flavors and aromas in a nutritional composition comprising an oxidizable oil. To illustrate various aspects of the general inventive concepts, several exemplary embodiments of nutritional compositions and methods are provided herein.

In one exemplary embodiment, a liquid nutritional composition having a pH of 6 to 8 is provided. The liquid nutritional composition includes a protein, a carbohydrate, and an oxidizable oil containing an unsaturated fatty acid. The liquid nutritional composition also includes rosmarinic acid. In one exemplary embodiment, the liquid nutritional composition is in the form of an aqueous emulsion having a continuous aqueous phase and a discontinuous non-aqueous phase.

In one exemplary embodiment, the liquid nutritional composition comprises 0.0004 wt % to 0.04 wt % rosmarinic acid. In one exemplary embodiment, the rosmarinic acid is provided by a water-soluble rosemary extract.

In one exemplary embodiment, the oxidizable oil comprises fish oil containing an omega-3 polyunsaturated fatty acid. In one exemplary embodiment, the omega-3 polyunsaturated fatty acid comprises eicosapentaenoic acid and docosahexaenoic acid. In one exemplary embodiment, a weight ratio of eicosapentaenoic acid to docosahexaenoic acid is 1:5 to 5:1.

In one exemplary embodiment, the protein comprises 2 wt % to 15 wt % of the liquid nutritional composition, the carbohydrate comprises 5 wt % to 25 wt % of the liquid nutritional composition. In one exemplary embodiment, the liquid nutritional composition comprises 0.5 wt % to 20 wt % of fat (including the oxidizable oil).

In one exemplary embodiment, a method of reducing off-flavors and aromas in a liquid nutritional composition comprising an oxidizable oil and having a pH of 6 to 8 is provided. The method includes: (a) preparing an aqueous solution comprising protein, carbohydrate, and 0.0004 wt % to 0.2 wt % of rosmarinic acid; (b) preparing an oil blend comprising an oxidizable oil containing an unsaturated fatty acid; and (c) mixing together the aqueous solution and the oil blend to form the liquid nutritional composition.

In one exemplary embodiment, preparing the aqueous solution includes: (a) preparing a protein slurry comprising water and protein; (b) preparing a carbohydrate slurry comprising water and carbohydrate; (c) mixing together the protein slurry and the carbohydrate slurry to form the aqueous solution; and (d) adding a source of rosmarinic acid to at least one of the protein slurry, the carbohydrate slurry, and the aqueous solution such that the aqueous solution comprises 0.0004 wt % to 0.2 wt % of rosmarinic acid. In one exemplary embodiment, the source of rosmarinic acid is a water-soluble rosemary extract.

### DETAILED DESCRIPTION

While the general inventive concepts are susceptible of embodiment in many different forms, described herein in detail are specific embodiments thereof with the understanding that the present disclosure is to be considered as an exemplification of the principles of the general inventive concepts. Accordingly, the general inventive concepts are not intended to be limited to the specific embodiments illustrated and described herein.

The terminology as set forth herein is for description of the embodiments only and should not be construed as limiting the disclosure as a whole. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

Any combination of method or process steps as used herein may be performed in any order, unless otherwise specified or clearly implied to the contrary by the context in which the referenced combination is made.

The term “fat” as used herein, unless otherwise specified, refers to lipids, fats, oils, and combinations thereof.

The term “oxidizable oil” as used herein, unless otherwise specified, refers to an oil that is susceptible to oxidation by virtue of containing unsaturated fatty acids, particularly polyunsaturated fatty acids.

The terms “polyunsaturated fatty acid” and “PUFA” as used herein, unless otherwise specified, refer to any polyunsaturated fatty acid or source thereof, including short chain (less than about 6 carbon atoms per chain), medium chain (about 6 to about 18 carbon atoms per chain), and long chain (having at least about 20 carbon atoms per chain) fatty acids having two or more points of unsaturation (i.e., two or more carbon-carbon double bonds).

In one exemplary embodiment, a liquid nutritional composition having a pH of 6 to 8 is provided. The liquid nutritional composition comprises a protein, a carbohydrate, an oxidizable oil containing an unsaturated fatty acid, and rosmarinic acid. In one exemplary embodiment, the liquid nutritional composition is in the form of an aqueous emulsion having a continuous aqueous phase and a discontinuous non-aqueous phase.

The use of an oxidizable oil containing an unsaturated fatty acid can result in the liquid nutritional composition having off-flavors and aromas. Such off-flavors and aromas are often described as fishy, painty, or otherwise rancid, and generally result from the oxidation of the unsaturated fatty acids, particularly polyunsaturated fatty acids, in the oxidizable oil. In the exemplary liquid nutritional compositions and methods described herein, it was unexpectedly discovered that rosmarinic acid may be utilized to effectively protect the flavor and aroma of liquid nutritional compositions comprising an oxidizable oil containing an unsaturated fatty acid, particularly when the liquid nutritional composition is in the form of an aqueous emulsion and contains omega-3 polyunsaturated fatty acids. The flavor and aroma protection provided by the rosmarinic acid was particularly unexpected because current technologies indicate that rosmarinic acid (a polar, hydrophilic compound) exhibits less antioxidant activity in aqueous emulsion systems than non-polar, oil-soluble compounds, such as carnosic acid and carnosol.

As mentioned, the exemplary liquid nutritional composition includes an oxidizable oil containing an unsaturated fatty acid. In one exemplary embodiment, the unsaturated fatty acid comprises a monounsaturated fatty acid (MUFA), a polyunsaturated fatty acid (PUFA), or both a MUFA and a PUFA. For example, in certain exemplary embodiments, the unsaturated fatty acid contained in the oxidizable oil comprises a PUFA, such as an omega-3 PUFA, an omega-6 PUFA, or both an omega-3 PUFA and an omega-6 PUFA. In certain exemplary embodiments, the unsaturated fatty acid contained in the oxidizable oil comprises an omega-3 PUFA. Exemplary omega-3 PUFAs include, but are not limited to, alpha-linolenic acid (ALA), eicosapentaenoic acid (EPA), and docosahexaenoic acid (DHA). In certain exemplary embodiments, the liquid nutritional composition comprises 0.005 wt % to 5 wt % of omega-3 PUFAs. For example, in certain exemplary embodiments, the liquid nutritional composition comprises 0.005 wt % to 4.75 wt %, including 0.01 wt % to 4.5 wt %, 0.05 wt % to 4 wt %, 0.1 wt % to 3.5 wt %, 0.5 wt % to 3 wt %, 0.75 wt % to 2.5 wt %, 1 wt % to 2 wt %, or 2 wt % to 5 wt % of omega-3 PUFAs. In one exemplary embodiment, the omega-3 PUFA comprises DHA. In one exemplary embodiment, the omega-3 PUFA comprises EPA and DHA. In certain exemplary embodiments, the EPA and DHA are present at a weight ratio of 1:5 to 5:1. For example, in certain embodiments, the weight ratio of EPA to DHA is 1:5 to 5:1, including 1:4 to 4:1, 1:3 to 3:1, or 1:2 to 2:1.

In certain exemplary embodiments, the unsaturated fatty acid contained in the oxidizable oil comprises an omega-6 PUFA. Exemplary omega-6 PUFAs include, but are not limited to, linoleic acid (LA), gamma-linolenic acid (GLA), dihomo-gamma-linolenic acid (DGLA), and arachidonic acid (AA). In certain exemplary embodiments, the liquid nutritional composition comprises 0.005 wt % to 7 wt % of omega-6 PUFAs. For example, in certain exemplary embodiments, the liquid nutritional composition comprises 0.005 wt % to 5 wt % of omega-6 PUFAs, including 0.01 wt % to 4.5 wt %, 0.05 wt % to 4 wt %, 0.1 wt % to 3.5 wt %, 0.5 wt % to 3 wt %, 0.75 wt % to 2.5 wt %, 1 wt % to 2 wt %, or 2 wt % to 7 wt % of omega-6 PUFAs. In one exemplary embodiment, the omega-6 PUFA comprises gamma-linolenic acid.

In certain exemplary embodiments, the unsaturated fatty acid contained in the oxidizable oil comprises an omega-3 PUFA and an omega-6 PUFA. For example, in certain exemplary embodiments, the unsaturated fatty acid comprises at least one omega-3 PUFA, such as ALA, EPA, and DHA, and at least one omega-6 PUFA, such as LA, GLA, DGLA, and AA. In one exemplary embodiment, the unsaturated fatty acid in the oxidizable oil comprises DHA and GLA. In one exemplary embodiment, the unsaturated fatty acid in the oxidizable oil comprises DHA, GLA, and EPA. It should be understood that the oxidizable oil may comprise one oxidizable oil or multiple (e.g., two, three, four) oxidizable oils.

Exemplary oxidizable oils suitable for use in the liquid nutritional composition include fish oil, algal oil, canola oil, flaxseed oil, borage oil, safflower oil, high oleic safflower oil, high gamma-linolenic acid (GLA) safflower oil, corn oil, soy oil, sunflower oil, high oleic sunflower oil, and cottonseed oil. In addition, any combination of the preceding exemplary oxidizable oils may be used in the liquid nutritional composition.

In one exemplary embodiment, the oxidizable oil comprises fish oil containing an omega-3 PUFA. As used herein, the term “fish oil” refers to oil derived from the tissues of oily fish. The fish oil may be provided by saltwater or fresh water fish including, but not limited to, albacore, menhaden, salmon, herring, mackerel, anchovies, and sardines. In certain exemplary embodiments, the fish oil may be a concentrated fish oil. In one exemplary embodiment, the fish oil comprises EPA and DHA. In one exemplary embodiment, the fish oil comprises EPA and DHA at a weight ratio of 1:5 to 5:1 (EPA to DHA). For example, in certain embodiments, the weight ratio of EPA to DHA is 1:5 to 5:1, including 1:4 to 4:1, 1:3 to 3:1, or 1:2 to 2:1. As previously mentioned, omega-3 PUFAs, such as EPA and DHA from fish oil, are particularly susceptible to oxidation, and when oxidized can impart unpleasant off-flavors and aromas (e.g., fishy notes) to the liquid nutritional composition.

To provide protection against the oxidation of the oxidizable oil and to reduce or otherwise mask any off-flavors and aromas, the exemplary liquid nutritional composition comprises rosmarinic acid. Rosmarinic acid is a water soluble compound found in a wide variety of plants and is known to exhibit antioxidant activity. By way of example only, rosmarinic acid is found in Ocimum basilicum (basil), Ocimum tenuiflorum (holy basil), Melissa officinalis (lemon balm), Rosmarinus officinalis (rosemary), Origanum majorana (marjoram), Salvia officinalis (sage), Thymus vulgaris (thyme), and peppermint. In one exemplary embodiment, the rosmarinic acid in the liquid nutritional composition is provided by a water-soluble rosemary extract. Exemplary water-soluble rosemary extracts include AquaROX™ extract available from Vitiva d.d. (Slovenia), StabilEnhance® WSR extract available from Naturex, Inc. (South Hackensack, N.J.), and Herbalox® Seasoning available from Kalsec, Inc. (Kalamazoo, Mich.). In certain other embodiments, the rosmarinic acid in the liquid nutritional composition may be provided by a water-soluble extract from one or more of the plant species listed above or other plants containing rosmarinic acid.

In one exemplary embodiment, the liquid nutritional composition comprises 0.0004 wt % to 0.04 wt % rosmarinic acid. For example, in certain exemplary embodiments, the liquid nutritional composition comprises 0.001 wt % to 0.02 wt % rosmarinic acid, including 0.002 wt % to 0.012 wt %, 0.004 wt % to 0.01 wt %, or 0.01 wt % to 0.04 wt % rosmarinic acid. This particular concentration range of rosmarinic acid has been found to be particularly effective for reducing or otherwise masking off-flavors and aromas that can develop in liquid nutritional compositions, particularly aqueous emulsions, containing oxidizable oil.

In addition to an oxidizable oil and rosmarinic acid, the exemplary liquid nutritional composition may comprise a protein and a carbohydrate, and may include a fat other than the oxidizable oil. A wide variety of sources and types of protein, carbohydrate, and fat can be used in the exemplary liquid nutritional compositions described herein.

In one exemplary embodiment, the liquid nutritional composition includes 3 grams to 30 grams of protein per serving of the liquid nutritional composition. For example, in certain exemplary embodiments, the liquid nutritional composition includes 3 grams to 25 grams of protein per serving of the liquid nutritional composition, including 5 grams to 20 grams, 5 grams to 15 grams, 5 grams to 10 grams, or 15 grams to 25 grams of protein per serving of the liquid nutritional composition.

Alternatively, the amount of protein in the liquid nutritional composition may be expressed in terms of a weight percent (wt %) of the liquid nutritional composition. For example, in one exemplary embodiment, the protein comprises 2 wt % to 15 wt % of the liquid nutritional composition. In certain exemplary embodiments, the protein comprises 2 wt % to 10 wt % of the liquid nutritional composition, including 2 wt % to 8 wt %, 2 wt % to 5 wt %, 3 wt % to 10 wt %, 5 wt % to 10 wt %, or 8 wt % to 12 wt % of the liquid nutritional composition.

Various sources of protein, including one source or more than one source, may be utilized in the exemplary liquid nutritional composition. For example, the source of protein may include, but is not limited to, intact, hydrolyzed, and partially hydrolyzed protein, which may be derived from any known or otherwise suitable source such as milk (e.g., casein, whey), animal (e.g., meat, fish), cereal (e.g., rice, corn), vegetable (e.g., soy, pea), and combinations thereof. The source of protein may also include a mixture amino acids (often described as free amino acids) known for use in nutritional products or a combination of such amino acids with the intact, hydrolyzed, and partially hydrolyzed proteins described herein. The amino acids may be naturally occurring or synthetic amino acids.

More particular examples of sources of protein which may be suitable for use in the exemplary liquid nutritional compositions described herein include, but are not limited to, whey protein concentrates, whey protein isolates, whey protein hydrolysates, acid caseins, sodium caseinates, calcium caseinates, potassium caseinates, casein hydrolysates, milk protein concentrates, milk protein isolates, milk protein hydrolysates, nonfat dry milk, condensed skim milk, soy protein concentrates, soy protein isolates, soy protein hydrolysates, pea protein concentrates, pea protein isolates, pea protein hydrolysates, collagen proteins, collagen protein isolates, rice proteins, potato proteins, earthworm proteins, insect proteins, and combinations thereof. The nutritional compositions can include any individual source of protein or combination of the various sources of protein listed above.

In one exemplary embodiment, the liquid nutritional composition includes 15 grams to 110 grams of carbohydrate per serving of the liquid nutritional composition. For example, in certain exemplary embodiments, the liquid nutritional composition includes 25 grams to 90 grams of carbohydrate per serving of the liquid nutritional composition, including 30 grams to 85 grams, 35 grams to 75 grams, or 40 grams to 60 grams of carbohydrate per serving of the liquid nutritional composition.

Alternatively, the amount of carbohydrate in the liquid nutritional composition may be expressed in terms of a weight percent of the liquid nutritional composition. For example, in one exemplary embodiment, the carbohydrate comprises 5 wt % to 25 wt % of the liquid nutritional composition. In certain exemplary embodiments, the carbohydrate comprises 5 wt % to 20 wt % of the liquid nutritional composition, including 5 wt % to 15 wt %, 5 wt % to 10 wt %, 10 wt % to 25 wt %, 10 wt % to 20 wt %, 15 wt % to 25 wt %, or 20 wt % to 25 wt % of the liquid nutritional composition.

Carbohydrates suitable for use in the exemplary liquid nutritional compositions described herein may be simple, complex, variations, or combinations thereof. Various sources of carbohydrate may be used so long as the source is suitable for use in a liquid nutritional composition and is otherwise compatible with any other selected ingredients or features present in the liquid nutritional composition. Non-limiting examples of a source of carbohydrate suitable for use in the exemplary liquid nutritional compositions described herein include maltodextrin, hydrolyzed starch, glucose polymers, corn syrup, corn syrup solids, rice-derived carbohydrates, sucrose, glucose, fructose, lactose, high fructose corn syrup, honey, sugar alcohols, isomaltulose, sucromalt, pullulan, potato starch, corn starch, fructooligosaccharides, galactooligosaccharides, oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinoglactins, glucomannan, xanthan gum, alginate, pectin, low methoxy pectin, high methoxy pectin, cereal beta-glucans, carrageenan, psyllium, and combinations thereof. The liquid nutritional compositions may include any individual source of carbohydrate or combination of the various sources of carbohydrate listed above.

In one exemplary embodiment, the liquid nutritional composition includes 0.5 grams to 50 grams of fat (including the oxidizable oil) per serving of the liquid nutritional composition. For example, in certain exemplary embodiments, the liquid nutritional composition includes 1 gram to 46 grams of fat per serving of the liquid nutritional composition, including 1.25 grams to 40 grams, 5 grams to 35 grams, 10 grams to 25 grams, 15 gram to 20 grams, 1 gram to 5 grams, 20 grams to 50 grams, 30 grams to 50 grams, or 40 grams to 50 grams of fat per serving of the liquid nutritional composition.

Alternatively, the amount of fat in the liquid nutritional composition may be expressed in terms of a weight percent of the liquid nutritional composition. For example, in one exemplary embodiment, the fat (including the oxidizable oil) comprises 0.5 wt % to 20 wt % of the liquid nutritional composition. In certain exemplary embodiments, the fat comprises 0.5 wt % to 18 wt % of the liquid nutritional composition, including 0.5 wt % to 15 wt %, 0.5 wt % to 10 wt %, 0.5 wt % to 5 wt %, 2 wt % to 8 wt %, 5 wt % to 10 wt %, 8 wt % to 12 wt %, or 12 wt % to 18 wt % of the liquid nutritional composition. In certain other exemplary embodiments, the fat (including the oxidizable oil) comprises 15 wt % to 20 wt % of the liquid nutritional composition.

As previously discussed, the exemplary liquid nutritional composition includes an oxidizable oil. Accordingly, the liquid nutritional composition may include any one or more of the oxidizable oils previously discussed as a source of fat. In addition, in one exemplary embodiment, the liquid nutritional composition includes at least one fat, or source thereof, in combination with the oxidizable oil. For example, in one exemplary embodiment, the fat in the liquid nutritional composition further comprises a fat selected from the group consisting of coconut oil, fractionated coconut oil, medium chain triglycerides (MCT) oil, palm oil, palm kernel oil, palm olein, and combinations thereof.

The concentration and relative amounts of protein, carbohydrate, and fat in the exemplary liquid nutritional compositions can vary considerably depending upon, for example, the specific dietary needs of the intended user. In one exemplary embodiment, the liquid nutritional composition comprises protein in an amount of 2 wt % to 15 wt % of the liquid nutritional composition, carbohydrate in an amount of 5 wt % to 25 wt % of the liquid nutritional composition, and fat (including the oxidizable oil) in an amount of 0.5 wt % to 12 wt % of the liquid nutritional composition. In certain exemplary embodiments, the amount of protein, carbohydrate, and fat in the exemplary liquid nutritional composition may alternatively be expressed in terms of the percentage of total calories provided by the particular macronutrient, or a concentration (e.g., grams of macronutrient per 100 mL of the liquid nutritional composition), as shown below in Table 1.

TABLE 1

| | Embodiments | | |
|---|---|---|---|
| Macronutrient | A | B | C |
| Protein - % of total calories | 5-40 | 10-30 | 15-25 |
| Carbohydrate - % of total calories | 10-70 | 20-60 | 40-60 |
| Fat* - % of total calories | 10-65 | 10-50 | 15-35 |
| Protein - g/100 mL | 0.5-30 | 1-15 | 2-10 |
| Carbohydrate - g/100 mL | 1-40 | 4-30 | 10-20 |
| Fat* - g/100 mL | 0.1-30 | 0.5-15 | 1-5 |

*Fat includes the oxidizable oil.

A serving of the liquid nutritional composition may vary widely depending on, for example, the intended user. For example, a serving of the liquid nutritional composition may be 30 milliliters (mL) to 500 mL (˜1 fl oz to ˜17 fl oz). In certain exemplary embodiments, a serving of the liquid nutritional composition is 110 mL to 500 mL (˜3.7 fl oz to ˜17 fl oz), including 110 mL to 417 mL (˜3.7 fl oz to ˜14 fl oz), 120 mL to 500 mL (˜4 fl oz to ˜17 fl oz), 120 mL to 417 mL (˜4 fl oz to ˜14 fl oz), 177 mL to 417 mL (˜6 fl oz to ˜14 fl oz), 207 mL to 296 mL (˜7 fl oz to ˜10 fl oz), 230 mL to 245 mL (˜7.7 fl oz to ˜8.2 fl oz), 110 mL to 237 mL (˜3.7 fl oz to ˜8 fl oz), 120 mL to 237 mL (˜4 fl oz to ˜8 fl oz), 110 mL to 150 mL (˜3.7 fl oz to ˜5 fl oz), or 120 mL to 150 mL (˜4 fl oz to ˜5 fl oz). Generally as used herein, a serving may be construed as any amount which is intended to be consumed in one sitting or within one hour or less.

The exemplary liquid nutritional compositions described herein are useful to provide supplemental, primary, or sole sources of nutrition. In one exemplary embodiment, the liquid nutritional composition has a caloric density of 0.5 kcal/mL to 3 kcal/mL. In certain exemplary embodiments, the liquid nutritional composition has a caloric density of 0.5 kcal/mL to 2.5 kcal/mL, including 0.5 kcal/mL to 2 kcal/mL, 0.5 kcal/mL to 1.5 kcal/mL, 0.5 kcal/mL to 1 kcal/mL, 0.5 kcal/mL to 0.8 kcal/mL, 1 kcal/mL to 3 kcal/mL, 1.5 kcal/mL to 3 kcal/mL, 2 kcal/mL to 3 kcal/mL, or 2.5 kcal/mL to 3 kcal/mL.

In one exemplary embodiment, the liquid nutritional composition includes at least one antioxidant in addition to the rosmarinic acid. For example, in certain exemplary embodiments, the liquid nutritional composition further comprises at least one antioxidant selected from the group consisting of ascorbic acid, ascorbyl palmitate, retinyl palmitate, tocopherols, ascorbate salts, carotenoids, oil-soluble rosemary extract, and combinations thereof. Tocopherols suitable for use in the liquid nutritional composition may be natural or synthetic and include, but are not limited to, alpha-tocopherol, d-alpha-tocopherol (RRR-alpha-tocopherol), beta-tocopherol, gamma-tocopherol, delta-tocopherol, d,l-alpha-tocopherol (All-rac-alpha-tocopherol), tocopherol acetate, and combinations thereof. The term “tocopherol” as used herein, unless otherwise specified, also includes tocotrienols. Carotenoids suitable for use in the liquid nutritional composition include, but are not limited to, beta-carotene, lutein, lycopene, zeaxanthin, and combinations thereof. The oil-soluble rosemary extract includes carnosic acid and carnosol as active ingredients. Exemplary oil-soluble rosemary extracts include SyneROX™ extract available from Vitiva d.d. (Slovenia) and StabilEnhance® OSR extract available from Naturex, Inc. (South Hackensack, N.J.).

In one exemplary embodiment, the liquid nutritional composition may further comprise one or more additional components that may modify the physical, chemical, aesthetic, or processing characteristics of the liquid nutritional composition or serve as additional nutritional components. Non-limiting examples of additional components include preservatives, emulsifying agents (e.g., lecithin), buffers, sweeteners including artificial sweeteners (e.g., saccharine, aspartame, acesulfame K, sucralose), colorants, flavorants, thickening agents, stabilizers, and so forth.

In one exemplary embodiment, the liquid nutritional composition may further include vitamins or related nutrients, non-limiting examples of which include vitamin A, vitamin B₁₂, vitamin C, vitamin D, vitamin K, thiamine, riboflavin, pyridoxine, niacin, folic acid, pantothenic acid, biotin, choline, inositol, salts and derivatives thereof, and combinations thereof.

In one exemplary embodiment, the liquid nutritional composition may further include minerals, non-limiting examples of which include calcium, phosphorus, magnesium, zinc, manganese, sodium, potassium, molybdenum, chromium, chloride, and combinations thereof.

As previously discussed, the use of an oxidizable oil containing an unsaturated fatty acid in a liquid nutritional composition can result in the liquid nutritional composition having off-flavors and aromas due to the oxidation of the oxidizable oil. Accordingly, in one exemplary embodiment, a method of reducing off-flavors and aromas in a liquid nutritional composition comprising an oxidizable oil and having a pH of 6 to 8 is provided. The method includes: (a) preparing an aqueous solution comprising protein, carbohydrate, and 0.0004 wt % to 0.2 wt % of rosmarinic acid; (b) preparing an oil blend comprising an oxidizable oil containing an unsaturated fatty acid; and (c) mixing together the aqueous solution and the oil blend to form the liquid nutritional composition. Any of the exemplary liquid nutritional compositions described herein may be prepared in accordance with this exemplary method.

In one exemplary embodiment, preparing the aqueous solution comprises: (a) preparing a protein slurry comprising water and protein; (b) preparing a carbohydrate slurry comprising water and carbohydrate; (c) mixing together the protein slurry and the carbohydrate slurry to form the aqueous solution; and (d) adding a source of rosmarinic acid to at least one of the protein slurry, the carbohydrate slurry, and the aqueous solution such that the aqueous solution comprises 0.0004 wt % to 0.2 wt % of rosmarinic acid. In certain exemplary embodiments, a source of rosmarinic acid is added to at least one of the protein slurry, the carbohydrate slurry, and the aqueous solution such that the aqueous solution comprises 0.001 wt % to 0.2 wt % of rosmarinic acid, including 0.005 wt % to 0.15 wt %, 0.01 wt % to 0.1 wt %, 0.05 wt % to 0.15 wt %, or 0.1 wt % to 0.2 wt %. The protein slurry may be prepared, according to one exemplary embodiment, by heating the required amount of water to a temperature of 60° C. to 70° C. and mixing in the required amount of protein. The protein may be one or more of the proteins described herein, such as sodium caseinate, hydrolyzed sodium caseinate, and whey protein concentrate. The carbohydrate slurry may be prepared, according to one exemplary embodiment, by heating the required amount of water to a temperature of 60° C. to 75° C. and mixing in the required amount of carbohydrate. The carbohydrate may be one or more of the carbohydrates described herein, such as maltodextrin, sucrose, fructooligosaccharides, soy fiber, gum arabic, gellan gum, and so forth. In addition, the carbohydrate slurry may include minerals, preservatives, stabilizers, thickeners, and so forth.

In one exemplary embodiment, the source of rosmarinic acid is added to the protein slurry prior to forming the aqueous solution by mixing together the protein slurry and the carbohydrate slurry. In one exemplary embodiment, the source of rosmarinic acid is added to the carbohydrate slurry prior to forming the aqueous solution by mixing together the protein slurry and the carbohydrate slurry. In one exemplary embodiment, the source of rosmarinic acid is added to the aqueous solution, which is formed by mixing together the protein slurry and the carbohydrate slurry. The source of rosmarinic acid may be any of the sources described herein. In one exemplary embodiment, the source of rosmarinic acid is a water-soluble rosemary extract.

The oil blend comprising an oxidizable oil containing an unsaturated fatty acid may be prepared, according to one exemplary embodiment, by heating the required amount of fats and oxidizable oils to a temperature of 25° C. to 35° C., and mixing in an emulsifying agent, such as lecithin. In certain exemplary embodiments, the oil blend further comprises at least one antioxidant. The fats and oxidizable oils may be one or more of the fats and oxidizable oils described herein, such as fish oil, fractionated coconut oil, canola oil, soy oil, and so forth. Similarly, the at least one antioxidant may be one or more of the antioxidants described herein, such as ascorbyl palmitate, mixed tocopherols, oil-soluble rosemary extract, and so forth. In addition, the oil blend may further comprise oil soluble vitamins including, but not limited to, vitamin A, vitamin D, vitamin E, vitamin K, and combinations thereof.

It should be understood that when discussing the liquid nutritional compositions disclosed herein, the discussion is equally applicable to nutritional compositions that are produced according to the exemplary methods described herein. In other words, in certain exemplary embodiments, the exemplary methods can be viewed as methods for preparing the exemplary liquid nutritional compositions described herein. However, it should also be understood that the exemplary methods described herein can also be used to prepare nutritional compositions that vary in one or more ways from the exemplary liquid nutritional compositions described herein.

In one exemplary embodiment, the aqueous solution and the oil blend are blended together with heat and agitation to form the liquid nutritional composition. In one exemplary embodiment, the pH of the liquid nutritional composition may be adjusted to the desired pH range (e.g., from 6.8 to 7). In one exemplary embodiment, the liquid nutritional composition is heat treated and homogenized. For example, the heat treatment is utilized to sterilize the liquid nutritional composition, and may be performed, for example, by high-temperature short-time (“HTST”) processing or ultra-high temperature processing (“UHT”). Following heat treatment and homogenization, a water soluble vitamin solution may be added (if applicable), and the pH may be adjusted (if necessary), flavorant may be added, and any additional water may be added to adjust the solids content to the desired range. At this point, the liquid nutritional composition may optionally be packaged and sterilized according to any suitable sterilization technique (e.g., aseptic, retort, hot-fill, chemical, radiation, and filtering sterilization techniques).

### EXAMPLES

The following examples illustrate certain exemplary embodiments of the liquid nutritional compositions and methods described herein. The examples are given solely for the purpose of illustration and are not to be construed as limitations of the general inventive concepts, as many variations thereof are possible without departing from the spirit and scope of the general inventive concepts.

### Examples 1-2

Examples 1-2 illustrate exemplary embodiments of the liquid nutritional composition described herein. All ingredient amounts listed in Examples 1-2 are listed as kilogram per 1000 kg batch of the liquid nutritional composition, unless otherwise indicated.

TABLE 2

| | Example 1 | Example 2 |
|---|---|---|
| | Amount | Amount |
| INGREDIENTS | (kg/1000 kg) | (kg/1000 kg) |
| Water | Q.S. | Q.S. |
| Maltodextrin | 143.29 | 143.29 |
| Sodium Caseinate | 31.5 | 31.5 |
| Sodium Caseinate Hydrolyzed | 31.1 | 31.1 |
| Sucrose | 18.3 | 18.3 |
| Fish Oil | 14.4 | 14.4 |
| Fructooligosaccharide Powder | 11.5 | 11.5 |
| Gum Arabic | 8.5 | 8.5 |
| Whey Protein Concentrate (75%) | 3.8 | 3.8 |
| MCT Oil | 3.6 | 3.6 |
| Micronized Tricalcium Phosphate | 3.5 | 3.5 |
| Potassium Citrate | 2.9 | 2.9 |
| Magnesium Chloride | 2.8 | 2.8 |
| Sodium Citrate | 2.3 | 2.3 |
| Canola Oil | 2.1 | 2.1 |
| Flavoring | 2.0 | 2.0 |
| Soy Fiber | 1.7 | 1.7 |
| Soy Oil | 1.2 | 1.2 |
| Oil-Soluble Rosemary Extract | — | 0.9932 |
| Potassium Hydroxide (40%) | 0.9004 | 0.9004 |
| Lecithin | 0.8966 | 0.8966 |
| Ascorbic Acid | 0.7900 | 0.7900 |
| Choline Chloride | 0.5511 | 0.5511 |
| Potassium Chloride | 0.5171 | 0.5171 |
| Water-Soluble Rosemary Extract | 0.0440 | 0.0440 |
| Vitamin DEK Premix | 0.3990 | 0.3990 |
| Potassium Hydroxide | 0.3049 | 0.3049 |
| Vitamin Premix | 0.2600 | 0.2600 |
| Taurine | 0.2120 | 0.2120 |
| Vitamin E (RRR-d-alpha) | 0.1453 | 0.1453 |
| tocopheryl acetate | | |
| Zinc Sulfate | 0.0970 | 0.0970 |
| L-Carnitine | 0.0950 | 0.0950 |
| Gellan Gum | 0.0600 | 0.0600 |
| Ferrous Sulfate | 0.0220 | 0.0220 |
| Beta Carotene (30%) | 0.0182 | 0.0182 |
| Manganese Sulfate | 0.0127 | 0.0127 |
| Ascorbyl Palmitate | 0.0120 | 0.0120 |
| Vitamin A Palmitate | 0.0060 | 0.0060 |
| Cupric Sulfate | 0.0026 | 0.0026 |
| Sodium Bicarbonate | 0.0024 | 0.0024 |
| Tocopherol-2 (mixed tocopherols) | 0.0020 | 0.0020 |
| Folic Acid | 0.0016 | 0.0016 |
| Chromium Chloride | 0.000450 | 0.000450 |
| Sodium Molybdate | 0.000300 | 0.000300 |
| Potassium Iodide | 0.000198 | 0.000198 |
| Sodium Selenate | 0.000171 | 0.000171 |
| Vitamin K | 0.000037 | 0.000037 |

### Example 3

Example 3 illustrates the sensory performance of exemplary embodiments of the liquid nutritional composition containing fish oil and rosmarinic acid provided by a water-soluble rosemary extract compared to samples of liquid nutritional compositions containing fish oil and either no antioxidant system, or an antioxidant system that did not contain a water-soluble rosemary extract.

Eight 100 pound batches of liquid nutritional composition were prepared with a master protein slurry, a master carbohydrate slurry, and two separate oil systems, one containing no antioxidant system (“oil system 1”) and one containing ascorbyl palmitate and mixed tocopherols (“oil system 2”). The components of oil system 1 and oil system 2 are listed below in Tables 3-4. For batches containing a water-soluble rosemary extract, the required amount of the master protein slurry was weighed out and the required amount of the water-soluble rosemary extract was added. For batches containing an oil-soluble rosemary extract, the required amount of oil system 2 was weighed out and the required amount of the oil-soluble rosemary extract was added. For each batch, the required amount of carbohydrate slurry was added to the required amount of protein slurry, and then the required amount of the appropriate oil system was added to the combined carbohydrate and protein slurry.

TABLE 3
Oil System 1

| Ingredient | Oil System Percentage |
|---|---|
| Fish Oil | 64.9% |
| Fractionated Coconut Oil | 16.2% |
| Canola Oil | 9.5% |
| Soy Oil | 5.4% |
| Lecithin | 4.0% |

TABLE 4
Oil System 2

| Ingredient | Oil System Percentage |
|---|---|
| Fish Oil | 64.9% |
| Fractionated Coconut Oil | 16.2% |
| Canola Oil | 9.5% |
| Soy Oil | 5.4% |
| Lecithin | 4.0% |
| Ascorbyl Palmitate | 1200 ppm (of oil system) |
| Mixed Tocopherols | 200 ppm (of oil system) |

The eight separate 100 pound batches of liquid nutritional composition included different antioxidant systems to investigate the ability of a water-soluble rosemary extract to improve the sensory performance of a liquid nutritional composition containing fish oil, such as by inhibiting oxidation of the fish oil and/or reducing or otherwise masking off-flavors and aromas (e.g., fishy notes). The antioxidant system of each batch is shown below in Table 5.

TABLE 5
Antioxidant System

| | |
|---|---|
| Batch 1 | No antioxidant system (Oil System 1) |
| Batch 2 | Ascorbyl Palmitate (1200 ppm of Oil System 2) |
| | Mixed Tocopherols (200 ppm of Oil System 2) |
| Batch 3 | Oil-soluble rosemary extract (~4% w/w carnosic acid) (0.12 g) |
| | Ascorbyl Palmitate (1200 ppm of Oil System 2) |
| | Mixed Tocopherols (200 ppm of Oil System 2) |
| Batch 4 | Water-soluble rosemary extract (~10% w/w rosmarinic acid) |
| | (18.14 g) |
| | Ascorbyl Palmitate (1200 ppm of Oil System 2) |
| | Mixed Tocopherols (200 ppm of Oil System 2) |
| Batch 5 | Oil-soluble rosemary extract (~4% w/w carnosic acid) (0.12 g) |
| | Water-soluble rosemary extract (~10% w/w rosmarinic acid) |
| | (18.14 g) |
| | Ascorbyl Palmitate (1200 ppm of Oil System 2) |
| | Mixed Tocopherols (200 ppm of Oil System 2) |
| Batch 6 | Oil-soluble rosemary extract (~4-5% w/w carnosic acid) (0.2% |
| | of Oil System 2) |
| | Ascorbyl Palmitate (1200 ppm of Oil System 2) |
| | Mixed Tocopherols (200 ppm of Oil System 2) |
| Batch 7 | Water-soluble rosemary extract (~4-4.5% w/w rosmarinic acid) |
| | (136.08 g) |
| | Ascorbyl Palmitate (1200 ppm of Oil System 2) |
| | Mixed Tocopherols (200 ppm of Oil System 2) |
| Batch 8 | Oil-soluble rosemary extract (~4-5% w/w carnosic acid) (0.2% |
| | of Oil System 2) |
| | Water-soluble rosemary extract (~4-4.5% w/w rosmarinic acid) |
| | (136.08 g) |
| | Ascorbyl Palmitate (1200 ppm of Oil System 2) |
| | Mixed Tocopherols (200 ppm of Oil System 2) |

A sample from each batch was analyzed for intensity of various tastes and characteristics, including for example: sweet, salt, sour, fishy, bitter, cooked caseinate, vanilla, drying, sticky, cooked cereal, and starchy. Specifically, after the samples were prepared, four trained descriptive flavor panelists tasted each sample. The samples were at room temperature (e.g., about 20-22° C.) when tasted. After tasting, each panelist assessed the flavor attributes of the sample using a scoring system set forth in Table 6 below and the results were then averaged. The results are shown in Table 7.

TABLE 6

| Scale | Description |
|---|---|
| )( | Threshold |
| ½ | Very Slight |
| 1 | Slight |
| 1½ | Slight to Moderate |
| 2 | Moderate |
| 2½ | Moderate to Strong |
| 3 | Strong |

TABLE 7

| | Batch 1 | Batch 2 | Batch 3 | Batch 4 | Batch 5 | Batch 6 | Batch 7 | Batch 8 |
|---|---|---|---|---|---|---|---|---|
| Sweet | 1 | 1 | 1 | 1½ | 1½ | 1½ | 1½ | 1½ |
| Salt | ½ | ½ | ½ | ½ | ½ | ½ | ½ | ½ |
| Sour | 1 | 1 | 1 | 1 | 1 | 1 | 1 | 1 |
| Fishy | 1½ | 1 | 1 | ½ | ½ | ½ | )( | )( |
| Bitter | ½ | ½ | ½ | ½ | ½ | ½ | ½ | ½ |
| Cooked | 1 | 1 | 1 | 1 | 1 | 1 | 1 | 1 |
| Caseinate | | | | | | | | |
| Vanilla | 1 | 1 | 1 | 1 (creamy, | 1 | 1 | 1½ | 1½ |
| | (creamy, | (creamy) | (creamy) | red fruity) | (creamy) | (creamy, | (solventy, | (sl. solventy, |
| | spicy) | | | | | fruity) | butterscotch, | butterscotch, |
| | | | | | | | fruity) | fruity) |
| Drying | 1½ | 1½ | 1½ | 1½ | 1½ | 1½ | 1½ | 1½ |
| Sticky | 1 | 1 | 1 | 1 | 1 | 1 | 1 | 1 |
| Cooked | — | 1 | ½ | ½ | 1 | 1 | ½ | 1 |
| Cereal | | | | | | | | |
| Starchy | — | — | ½ | ½ | ½ | ½ | ½ | ½ |

The results of the sensory evaluation indicate that batches of the liquid nutritional composition containing a water-soluble rosemary extract (Batches 4, 5, 7, and 8) exhibited less fishy notes as compared to a liquid nutritional composition with no antioxidant system (Batch 1) and a liquid nutritional composition with an ascorbyl palmitate and mixed tocopherols antioxidant system (Batch 2). In addition, a liquid nutritional composition containing a water-soluble rosemary extract, ascorbyl palmitate, and mixed tocopherols (Batch 4) exhibited less fishy notes than a liquid nutritional composition having an oil-soluble rosemary extract, ascorbyl palmitate, and mixed tocopherols (Batch 3). Similarly, a liquid nutritional composition containing a water-soluble rosemary extract, ascorbyl palmitate, and mixed tocopherols (Batch 7) exhibited less fishy notes than a liquid nutritional composition having an oil-soluble rosemary extract, ascorbyl palmitate, and mixed tocopherols (Batch 6). Further, liquid nutritional compositions containing a water-soluble rosemary extract, ascorbyl palmitate, and mixed tocopherols (Batches 4 and 7) exhibited similar levels of fishy notes as compared to liquid nutritional compositions containing a water-soluble rosemary extract, an oil-soluble rosemary extract, ascorbyl palmitate, and mixed tocopherols (Batches 5 and 8).

The observed flavor and aroma protection provided by the water-soluble rosemary extract (rosmarinic acid) in Batches 4 and 7 was particularly unexpected since current technologies indicate that oil-soluble rosemary extracts exhibit far superior antioxidant activity in pH-neutral, aqueous emulsion systems as compared to water-soluble rosemary extracts.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Also, to the extent that the term “in” or “into” is used in the specification or the claims, it is intended to additionally mean “on” or “onto,” respectively. Furthermore, to the extent the term “connect” is used in the specification or claims, it is intended to mean not only “directly connected to” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative compositions and processes, and illustrative examples shown and described. Accordingly, departures may be made from such details without departing from the spirit or scope of the general inventive concept.

1. A liquid nutritional composition having a pH of 6 to 8, the composition comprising:
(a) a protein;
(b) a carbohydrate;
(c) an oxidizable oil containing an unsaturated fatty acid; and
(d) rosmarinic acid.

2. The liquid nutritional composition of claim 1, wherein the liquid nutritional composition comprises 0.0004 wt % to 0.04 wt % rosmarinic acid.

3. (canceled)

4. The liquid nutritional composition of claim 1, wherein the protein comprises 2 wt % to 15 wt % of the liquid nutritional composition and the carbohydrate comprises 5 wt % to 25 wt % of the liquid nutritional composition.

5. The liquid nutritional composition of claim 1, wherein the protein is selected from the group consisting of whey protein concentrates, whey protein isolates, whey protein hydrolysates, acid caseins, sodium casemates, calcium casemates, potassium casemates, casein hydrolysates, milk protein concentrates, milk protein isolates, milk protein hydrolysates, nonfat dry milk, condensed skim milk, soy protein concentrates, soy protein isolates, soy protein hydrolysates, pea protein concentrates, pea protein isolates, pea protein hydrolysates, collagen proteins, collagen protein isolates, rice proteins, potato proteins, earthworm proteins, insect proteins, and combinations thereof.

6. The liquid nutritional composition of claim 1, wherein the carbohydrate is selected from the group consisting of maltodextrin, hydrolyzed starch, glucose polymers, corn syrup, corn syrup solids, rice-derived carbohydrates, sucrose, glucose, fructose, lactose, high fructose corn syrup, honey, sugar alcohols, isomaltulose, sucromalt, pullulan, potato starch, corn starch, fructooligosaccharides, galactooligosaccharides, oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinoglactins, glucomannan, xanthan gum, alginate, pectin, low methoxy pectin, high methoxy pectin, cereal beta-glucans, carrageenan, psyllium, and combinations thereof.

7. The liquid nutritional composition of claim 1, further comprising a fat selected from the group consisting of coconut oil, fractionated coconut oil, medium chain triglycerides (MCT) oil, palm oil, palm kernel oil, palm olein, and combinations thereof.

8. (canceled)

9. The liquid nutritional composition of claim 1, further comprising at least one antioxidant selected from the group consisting of ascorbic acid, ascorbyl palmitate, retinyl palmitate, tocopherols, ascorbate salts, carotenoids, oil-soluble rosemary extract, and combinations thereof.

10. The liquid nutritional composition of claim 1, wherein the liquid nutritional composition has a caloric density of 0.5 kcal/mL to 3 kcal/mL.

11. The liquid nutritional composition of claim 1, wherein the liquid nutritional composition is in the form of an aqueous emulsion having a continuous aqueous phase and a discontinuous non-aqueous phase.

12. The liquid nutritional composition of claim 1, wherein the oxidizable oil comprises fish oil containing an omega-3 polyunsaturated fatty acid.

13. (canceled)

14. (canceled)

15. The liquid nutritional composition of claim 1, wherein the oxidizable oil is at least one of fish oil, algal oil, canola oil, flaxseed oil, borage oil, safflower oil, high oleic safflower oil, high gamma-linolenic acid (GLA) safflower oil, corn oil, soy oil, sunflower oil, high oleic sunflower oil, and cottonseed oil.

16. The liquid nutritional composition of claim 1, and 15, wherein the unsaturated fatty acid contained in the oxidizable oil comprises an omega-3 polyunsaturated fatty acid.

17.-19. (canceled)

20. The liquid nutritional composition of claim 1 and 15, wherein the unsaturated fatty acid contained in the oxidizable oil comprises an omega-6 polyunsaturated fatty acid.

21. (canceled)

22. A method of reducing off-flavors and aromas in a liquid nutritional composition comprising an oxidizable oil and having a pH of 6 to 8, the method comprising:
preparing an aqueous solution comprising protein, carbohydrate, and 0.0004 wt % to 0.2 wt % of rosmarinic acid;
preparing an oil blend comprising an oxidizable oil containing an unsaturated fatty acid; and
mixing together the aqueous solution and the oil blend to form the liquid nutritional composition.

23. The method of claim 22, further comprising heat treating the liquid nutritional composition, and homogenizing the liquid nutritional composition.

24. The method of claim 22, wherein preparing the aqueous solution comprises:
preparing a protein slurry comprising water and protein;
preparing a carbohydrate slurry comprising water and carbohydrate;
mixing together the protein slurry and the carbohydrate slurry to form the aqueous solution; and
adding a source of rosmarinic acid to at least one of the protein slurry, the carbohydrate slurry, and the aqueous solution such that the aqueous solution comprises 0.0004 wt % to 0.2 wt % of rosmarinic acid.

25. (canceled)

26. The method of claim 22, wherein the protein is selected from the group consisting of whey protein concentrates, whey protein isolates, whey protein hydrolysates, acid caseins, sodium casemates, calcium casemates, potassium casemates, casein hydrolysates, milk protein concentrates, milk protein isolates, milk protein hydrolysates, nonfat dry milk, condensed skim milk, soy protein concentrates, soy protein isolates, soy protein hydrolysates, pea protein concentrates, pea protein isolates, pea protein hydrolysates, collagen proteins, collagen protein isolates, rice proteins, potato proteins, earthworm proteins, insect proteins, and combinations thereof.

27. The method of claim 22, wherein the carbohydrate is selected from the group consisting of maltodextrin, hydrolyzed starch, glucose polymers, corn syrup, corn syrup solids, rice-derived carbohydrates, sucrose, glucose, fructose, lactose, high fructose corn syrup, honey, sugar alcohols, isomaltulose, sucromalt, pullulan, potato starch, corn starch, fructooligosaccharides, galactooligosaccharides, oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinoglactins, glucomannan, xanthan gum, alginate, pectin, low methoxy pectin, high methoxy pectin, cereal beta-glucans, carrageenan, psyllium, and combinations thereof.

28. The method of claim 22, wherein the oil blend further comprises a fat selected from the group consisting of coconut oil, fractionated coconut oil, medium chain triglycerides (MCT) oil, palm oil, palm kernel oil, palm olein, and combinations thereof.

29.-30. (canceled)

31. The method of claim 22, wherein the unsaturated fatty acid contained in the oxidizable oil comprises an omega-3 polyunsaturated fatty acid.

32.-36. (canceled)
